(19) United States
(12) Patent Application Publication
(10) Pub. No.: US 2024/0308815 A1
(43) Pub. Date: Sep. 19, 2024

(54) HOISTING PROTECTION DEVICE FOR CONTAINER TRANSPORTATION

(71) Applicant: Hebei Qinhuai Data Co., Limited., Zhangjiakou City (CN)

(72) Inventors: Binghua ZHANG, Zhangjiakou City (CN); Mingjiang LI, Zhangjiakou City (CN)

(21) Appl. No.: 18/595,502

(22) Filed: Mar. 5, 2024

(30) Foreign Application Priority Data
Mar. 15, 2023 (CN) 202310250770.0

(51) Int. Cl. B66C 1/22; B66C 19/00

(52) U.S. Cl. CPC B66C 1/223; B66C 19/007

(57) ABSTRACT

The present disclosure discloses a hoisting protection device for container transportation, including a transport shelf provided with a wheel. The transport shelf is provided with a protection mechanism and a locking mechanism, where the protection mechanism includes a support block in contact with the transport shelf. A fastening bolt is movably connected to the support block, the fastening bolt is connected to the transport shelf by means of screw thread, and a clamp slot is provided inside the fastening bolt. The support block comes into contact with an end plate, the end plate is fixedly connected to a locking plate, the locking plate is slidably connected to the support block, and the locking plate is slidably connected to the clamp slot. The support block is fixedly connected to a sliding plate, and the sliding plate is slidably connected to the locking plate.

### CROSS REFERENCE TO RELATED APPLICATION

This application claims priority to Chinese Patent Application No. 202310250770.0, titled “HOISTING PROTECTION DEVICE FOR CONTAINER TRANSPORTATION” and filed to the China National Intellectual Property Administration on Mar. 15, 2023, the entire contents of which are incorporated herein by reference.

### TECHNICAL FIELD

The present disclosure relates to the field of protection device, and more particularly, to a hoisting protection device for container transportation.

### BACKGROUND

As is well known, containers are common storage tools for loading goods, and need to be transported and used in conjunction with hoisting machinery. A hoisting protection device for container transportation is disclosed in a patent for invention with Published Application No. CN110526130A. The hoisting protection device for container transportation includes a driving component, a rotating rod, and a bearing member. The rotating rod is connected to the bearing member, and the driving component drives the rotating rod to rotate, thereby driving the bearing member to swing. When a container is hoisted with a hoisting sling, the bearing member is swung to come into contact with a bottom of the container to form support protection, which can effectively improve bearing strength of the bottom of the container.

However, an existing hoisting protection device for container transportation also has some shortcomings. First, in the existing hoisting protection device for container transportation, simply the bearing member is used to support the container, but no good protection mechanism is provided, making it difficult to effectively protect the container in case of accidental fall. Second, the existing bearing member is not provided with a good locking mechanism, making it difficult to accurately control first and second clamp plates, thereby unable to ensure to clamp and fix the container in use. Therefore, the existing hoisting protection device for container transportation needs to be improved.

### SUMMARY

Objectives of the present disclosure are to provide a hoisting protection device for container transportation to solve the above-mentioned problems, which solves the problems mentioned in the background technology.

To solve the aforementioned problems, the present disclosure provides following technical solutions.

A hoisting protection device for container transportation includes a transport shelf provided with a wheel, where the transport shelf is provided with a protection mechanism and a locking mechanism. The protection mechanism includes a support block in contact with the transport shelf, and a fastening bolt is movably connected to the support block. The fastening bolt is connected to the transport shelf by means of screw thread, and a clamp slot is provided inside the fastening bolt. The support block comes into contact with an end plate, the end plate is fixedly connected to a locking plate, the locking plate is slidably connected to the support block, and the locking plate is slidably connected to the clamp slot. The support block is fixedly connected to a sliding plate, and the sliding plate is slidably connected to the locking plate, where a first spring is welded onto the sliding plate, and other end of the first spring is welded to the locking plate. The transport shelf is slidably connected to two support plates in contact with each other, where each of the two support plates is fixedly connected to a guide rod, an outer side of the guide rod is slidably sleeved with a guide ball, and the guide ball is slidably connected to the support plate. A fixed cylinder is fixedly connected onto the support block, and the fixed cylinder is slidably connected to an expansion rod, where the expansion rod is fixedly connected to the guide ball, an outer side of the expansion rod is provided with a second spring, the outer side of the expansion rod is fixedly sleeved with a friction ring, a friction sleeve is fixedly connected to the fixed cylinder, and a friction groove is provided inside the friction sleeve.

The locking mechanism includes a motor fixedly installed on the transport shelf, and an output shaft is arranged on the motor, where the output shaft is rotatably connected to the transport shelf, and an outer side of the output shaft is fixedly sleeved with a first bevel gear. A first threaded rod is installed inside the transport shelf through a bearing, and an outer side of the first threaded rod is fixedly sleeved with a second bevel gear, which is meshed with the first bevel gear. A second threaded rod is installed inside the transport shelf through the bearing, where a thread direction of the second threaded rod is opposite to that of the first threaded rod. An outer side of the second threaded rod is fixedly sleeved with a third bevel gear, which is meshed with the first bevel gear. The outer side of the first threaded rod is connected to a first clamp plate by means of screw thread, where the first clamp plate is slidably connected to the transport shelf, and the first clamp plate comes into contact with a container body. The outer side of the second threaded rod is connected to a second clamp plate by means of screw thread.

In the hoisting protection device for container transportation of the present disclosure, a plurality of the clamp slots are provided, and the plurality of clamp slots are arranged in an annular array on the fastening bolt. Arrangement of the clamp slots is convenient for subsequent use in conjunction with the locking plate.

In the hoisting protection device for container transportation of the present disclosure, one end of the second spring is welded to the guide ball, and other end of the second spring is welded to the fixed cylinder. The guide ball may be connected for use by providing the second spring.

In the hoisting protection device for container transportation of the present disclosure, an elastic disc is fixedly connected to the expansion rod, where the elastic disc comes into contact with a friction sleeve, the elastic disc is fixedly connected to a friction block, and the friction block is slidably connected to the friction groove. Deformation stress of the second spring may be subjected to wear treatment by using the friction block in conjunction with the friction groove.

In the hoisting protection device for container transportation of the present disclosure, a plurality of the friction grooves are provided, and the plurality of friction grooves are arranged in an annular array on the friction sleeve. Arrangement of the friction grooves is convenient for use in conjunction with the friction block.

In the hoisting protection device for container transportation of the present disclosure, the second clamp plate is slidably connected to the transport shelf, and the second clamp plate comes into contact with the container body.

In the hoisting protection device for container transportation of the present disclosure, a clamp hole is provided in the output shaft, a clamp rod is slidably connected into the transport shelf, and the clamp rod is slidably connected to the clamp hole. A third spring is welded onto the clamp rod, and other end of the third spring is welded to the transport shelf. The output shaft may be subjected to limit treatment by using the clamp rod in conjunction with the clamp hole.

In the hoisting protection device for container transportation of the present disclosure, a plurality of the clamp holes are provided, and the plurality of clamp holes are arranged in an annular array on the output shaft. Arrangement of the clamp holes is convenient for use in conjunction with the clamp rod.

Beneficial effects of the present disclosure are described as below. The present disclosure relates to a hoisting protection device for container transportation, which can accurately control the first clamp plate and the second clamp plate, thereby clamping and fixing the container body, and effectively protecting the container body in case of accidental fall. In actual use, compared with conventional hoisting protection devices for container transportations, the hoisting protection device for container transportation of the present disclosure has the following beneficial effects.
1. There are provided structures such as the protection mechanism, the support block, the fastening bolt, the clamp slot, the end plate, the locking plate, the sliding plate, the first spring, the support plate, the guide rod, the guide ball, and the fixed cylinder. The support block can be locked by the fastening bolt. Under the action of the structures such as the clamp slot and the locking plate, long-term stability of the fastening bolt can be ensured, such that the support block can effectively support the fixed cylinder. Under the action of the structures such as the guide ball, the expansion rod, and the second spring, the support plate can be supported, and impact force can be buffered and released.
2. There are provided structures such as the anchor locking mechanism, the motor, the output shaft, the first bevel gear, the first threaded rod, the second bevel gear, the second threaded rod, and the third bevel gear. The motor drives the output shaft to rotate, thereby driving the first bevel gear to rotate, and then driving the second bevel gear and the third bevel gear to rotate, to push the first clamp plate and the second clamp plate to clamp and fix the container body. Furthermore, under the action of the structures such as the clamp hole and the clamp rod, the first clamp plate and the second clamp plate can be precisely controlled for use.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic diagram of an overall structure according to an embodiment of the present disclosure;

FIG. 2 is an enlarged view of a protection mechanism in FIG. 1;

FIG. 3 is an enlarged view at position A in FIG. 2;

FIG. 4 is an enlarged view at position B in FIG. 2;

FIG. 5 is an enlarged view of a local locking mechanism in FIG. 1; and

FIG. 6 is an enlarged view at position C in FIG. 5.

Reference numerals in the accompanying drawings: transport shelf 1; wheel 2; protection mechanism 3; locking mechanism 4; container body 5; support block 31; fastening bolt 32; clamp slot 33; end plate 34; locking plate 35; sliding plate 36; first spring 37; support plate 38; guide rod 39; guide ball 391; fixed cylinder 392; extension rod 393; second spring 3931; friction ring 394; friction sleeve 395; friction groove 396; elastic disc 397; friction block 398; motor 41; output shaft 42; first bevel gear 43; first threaded rod 44; second bevel gear 45; second threaded rod 46; third bevel gear 47; first clamp plate 48; second clamp plate 49; clamp hole 491; clamp rod 492; and third spring 493.

### DETAILED DESCRIPTION

Technical solutions in the embodiments of the present disclosure will be described clearly and completely below, in conjunction with the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should also be understood that the terms used in this specification of the present disclosure are only for the purpose of describing particular embodiments and are not intended to limit the present disclosure. As used in the specification and the appended claims of the present disclosure, the singular forms of “a”, “an” and “the” may be intended to include the plural forms, unless the context clearly indicates otherwise.

It should also be further understood that the term “and/or” used in the specification and the appended claims of the present disclosure refers to any combination of one or more of the relevantly listed items and all possible combinations, and includes these combinations.

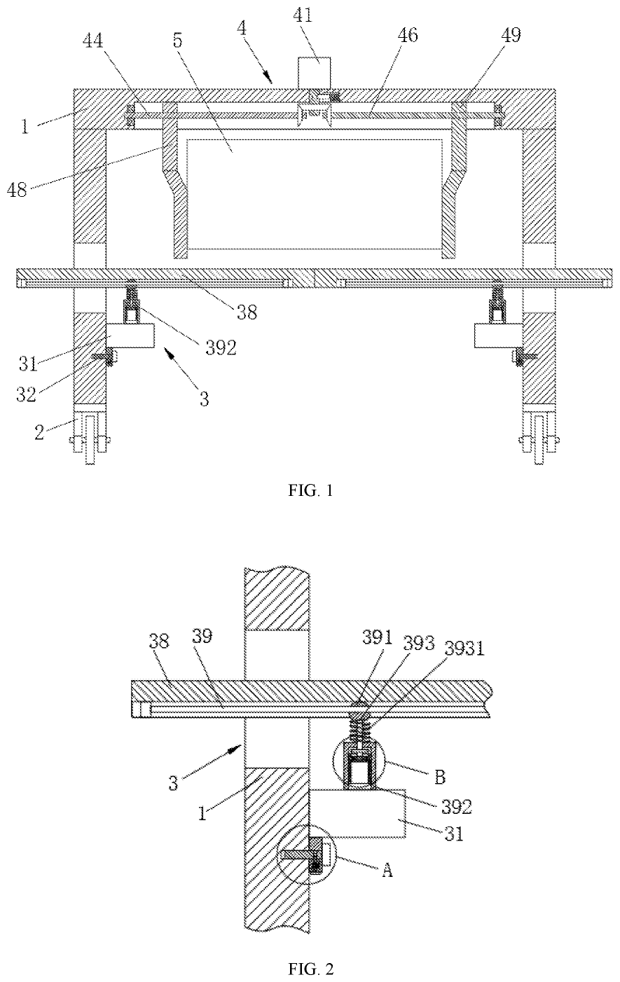

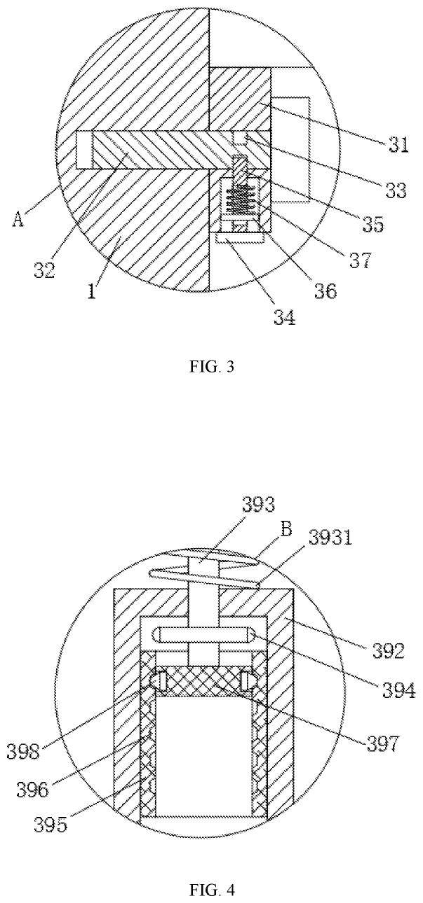

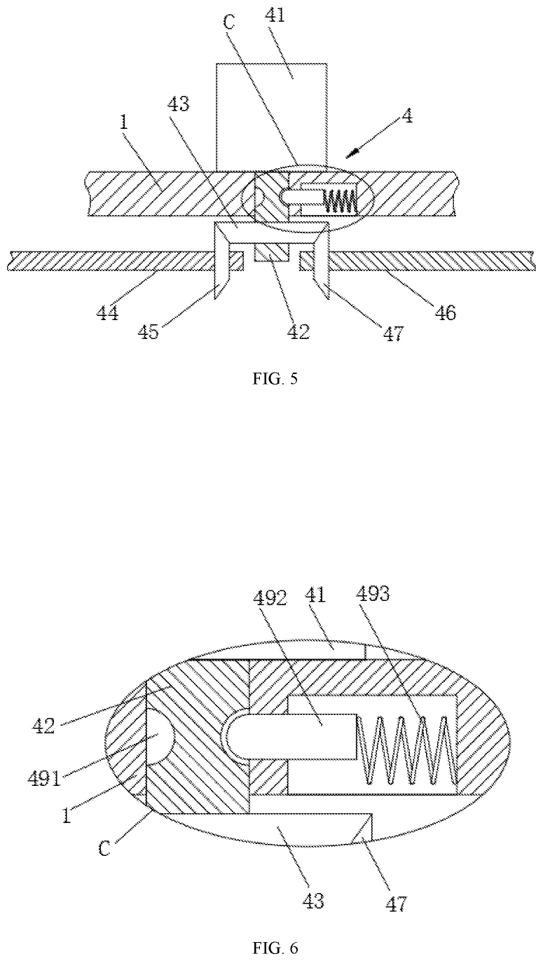

As shown in FIGS. 1 to 6, following technical solutions are adopted in this specific implementation manner.

### Embodiments

A hoisting protection device for container transportation includes a transport shelf 1 provided with a wheel 2, where the transport shelf 1 is provided with a protection mechanism 3. The protection mechanism 3 includes a support block 31 in contact with the transport shelf 1, and a fastening bolt 32 is movably connected to the support block 31. The fastening bolt 32 is connected to the transport shelf 1 by means of screw thread, and a clamp slot 33 is provided inside the fastening bolt 32. The support block 31 comes into contact with an end plate 34, the end plate 34 is fixedly connected to a locking plate 35, the locking plate 35 is slidably connected to the support block 31, and the locking plate 35 is slidably connected to the clamp slot 33. The support block 31 is fixedly connected to a sliding plate 36, and the sliding plate 36 is slidably connected to the locking plate 35, where a first spring 37 is welded onto the sliding plate 36, and other end of the first spring 37 is welded to the locking plate 35.

The transport shelf 1 is slidably connected to two support plates 38 in contact with each other, where each of the two support plates 38 is fixedly connected to a guide rod 39. An outer side of the guide rod 39 is slidably sleeved with a guide ball 391, and the guide ball 391 is slidably connected to the support plate 38. A fixed cylinder 392 is fixedly connected onto the support block 31, and the fixed cylinder 392 is slidably connected to an expansion rod 393, where the expansion rod 393 is fixedly connected to the guide ball 391. An outer side of the expansion rod 393 is provided with a second spring 3931, and the outer side of the expansion rod 393 is fixedly sleeved with a friction ring 394. A friction sleeve 395 is fixedly connected to the fixed cylinder 392, and a friction groove 396 is provided inside the friction sleeve 395. Arrangement of the second spring 3931 can effectively buffer an external force to reduce impact damage by the external force.

A plurality of the clamp slots 33 are provided, and the plurality of clamp slots 33 are arranged in an annular array on the fastening bolt 32. Arrangement of the clamp slots 33 is convenient for subsequent use in conjunction with the locking plate 35.

One end of the second spring 3931 is welded to the guide ball 391, and other end of the second spring 3931 is welded to the fixed cylinder 392.

An elastic disc 397 is fixedly connected to the expansion rod 393, where the elastic disc 397 comes into contact with the friction sleeve 395. The elastic disc 397 is fixedly connected to a friction block 398, where the friction block 398 is slidably connected to the friction groove 396. Deformation stress of the second spring 3931 may be subjected to wear treatment by using the friction block 398 in conjunction with the friction groove 396.

A plurality of the friction grooves 396 are provided, and the plurality of friction grooves 396 are arranged in an annular array on the friction sleeve 395. Arrangement of the friction grooves 396 is convenient for use in conjunction with the friction block 398.

A locking mechanism 4 is arranged on the transport shelf 1. The locking mechanism 4 includes a motor 41 fixedly installed on the transport shelf 1. An output shaft 42 is arranged on the motor 41, where the output shaft 42 is rotatably connected to the transport shelf 1. An outer side of the output shaft 42 is fixedly sleeved with a first bevel gear 43. A first threaded rod 44 is installed inside the transport shelf 1 through a bearing, where an outer side of the first threaded rod 44 is fixedly sleeved with a second bevel gear 45, which is meshed with the first bevel gear 43. A second threaded rod 46 is installed inside the transport shelf 1 through the bearing, where a thread direction of the second threaded rod 46 is opposite to that of the first threaded rod 44. An outer side of the second threaded rod 46 is fixedly sleeved with a third bevel gear 47, which is meshed with the first bevel gear 43. The outer side of the first threaded rod 44 is connected to a first clamp plate 48 by means of screw thread, where the first clamp plate 48 is slidably connected to the transport shelf 1, and the first clamp plate 48 comes into contact with a container body 5. The outer side of the second threaded rod 46 is connected to a second clamp plate 49 by means of screw thread. The second clamp plate 49 is slidably connected to the transport shelf 1, and the second clamp plate 49 comes into contact with the container body 5. Arrangement of the motor 41 and the first bevel gear 43 may drive the first threaded rod 44 and the second threaded rod 46 to rotate.

A clamp hole 491 is provided in the output shaft 42, and a clamp rod 492 is slidably connected into the transport shelf 1, where the clamp rod 492 is slidably connected to the clamp hole 491. A third spring 493 is welded onto the clamp rod 492, and other end of the third spring 493 is welded to the transport shelf 1. The output shaft 42 may be subjected to limit treatment by using the clamp rod 492 in conjunction with the clamp hole 491.

A plurality of the clamp holes 491 are provided, and the plurality of clamp holes 491 are arranged in an annular array on the output shaft 42. Arrangement of the clamp holes 491 is convenient for use in conjunction with the clamp rod 492.

Specific implementation processes of the present disclosure are as follows. When in use, the end plate 34 is pushed and pulled to move away from a direction of the support block 31 to drive the locking plate 35 to slide along a surface of the sliding plate 36. The first spring 37 is deformed under force, and then the fastening bolt 32 is pushed to pass through the support block 31 such that the fastening bolt 32 comes into contact with the transport shelf 1. The fastening bolt 32 is rotated, and in a threaded connection relationship, the fastening bolt 32 is fixedly installed. Next, the support block 31 is locked and fixed, and the end plate 34 is released to recover deformation of the first spring 37, such that the locking plate 35 is pushed to insert into the clamp slot 33 to limit the fastening bolt 32, thereby ensuring the long-term stability of the fastening bolt 32.

The motor 41 is started to drive the output shaft 42 to rotate, to drive the first bevel gear 43 to rotate. In a meshing relationship, the first bevel gear 43 drives the second bevel gear 45 and the third bevel gear 47 to rotate, thereby driving the first threaded rod 44 and the second threaded rod 46 to rotate. In the threaded connection relationship, a thread direction of the first threaded rod 44 is opposite to that of the second threaded rod 46, to drive the first clamp plate 48 and the second clamp plate 49 to move towards each other, thereby clamping and fixing the container body 5. During this process, the clamp hole 491 is forced to compress the clamp rod 492, such that the clamp rod 492 is forced to push the third spring 493 to deform, ultimately causing the clamp rod 492 to break away from the clamp hole 491. Under the action of force, the clamp rod 492 slides along the surface of the output shaft 42. When the clamp rod 492 slides into the next clamp hole 491 provided on the output shaft 42, the third spring 493 recovers deformation, such that the clamp rod 492 is pushed to insert into the clamp hole 491 to limit the output shaft 42. In this way, the first clamp plate 48 and the second clamp plate 49 are precisely controlled, thereby avoiding redundant movement of the first clamp plate 48 and the second clamp plate 49.

Next, the two support plates 38 are pushed to move towards each other, ultimately causing the two the support plates 38 to come into contact with each other. During this process, the guide ball 391 slides along a surface of the guide rod 39, to guide the support plate 38. In case of accidental fall of the container body 5, the container body 5 comes into contact with the support plate 38. The support plate 38 is pushed by force to drive the guide ball 391 to move, and thus the guide ball 391 is pushed by force to drive the expansion rod 393 to move, such that the expansion rod 393 drives the elastic disc 397 to slide along an inner wall of the friction sleeve 395, and the expansion rod 393 drives the friction ring 394 to slide into the friction sleeve 395. The friction groove 396 is forced to compress the friction block 398. The friction block 398 is pushed by force to deform the elastic disc 397. Finally, the friction block 398 breaks away from the friction groove 396. Under the action of force, the friction block 398 slides along the inner wall of the friction sleeve 395, over and over again. The friction block 398 continuously slides along the friction groove 396 and the inner wall of the friction sleeve 395, to wear excess deformation stress of the second spring 3931, thereby controlling elastic modulus of the second spring 3931 to effectively protect the container body 5.

The preceding descriptions are merely specific embodiments of the present disclosure, but are not intended to limit the protection scope of the present disclosure. Any equivalent modifications or replacements easily conceivable to a person of skilled in the art within the technical scope disclosed in the present disclosure shall fall within the protection scope of the present disclosure. Therefore, the protection scope of the present disclosure shall be subject to that of the claims.

What is claimed is:

1. A hoisting protection device for container transportation, comprising a transport shelf provided with a wheel, the transport shelf being provided with a protection mechanism and a locking mechanism, wherein the protection mechanism comprises a support block in contact with the transport shelf, and a fastening bolt is movably connected to the support block, the fastening bolt is connected to the transport shelf by means of screw thread, and a clamp slot is provided inside the fastening bolt, the support block comes into contact with an end plate, the end plate is fixedly connected to a locking plate, the locking plate is slidably connected to the support block, the locking plate is slidably connected to the clamp slot, the support block is fixedly connected to a sliding plate, the sliding plate is slidably connected to the locking plate, a first spring is welded onto the sliding plate, other end of the first spring is welded to the locking plate, the transport shelf is slidably connected to two support plates in contact with each other, each of the two support plates is fixedly connected to a guide rod, an outer side of the guide rod is slidably sleeved with a guide ball, the guide ball is slidably connected to the support plate, and a fixed cylinder is fixedly connected onto the support block, the fixed cylinder is slidably connected to an expansion rod, the expansion rod is fixedly connected to the guide ball, an outer side of the expansion rod is provided with a second spring, the outer side of the expansion rod is fixedly sleeved with a friction ring, a friction sleeve is fixedly connected to the fixed cylinder, and a friction groove is provided inside the friction sleeve; and
the locking mechanism comprises a motor, the motor is fixedly installed on the transport shelf, an output shaft is arranged on the motor, the output shaft is rotatably connected to the transport shelf, an outer side of the output shaft is fixedly sleeved with a first bevel gear, and a first threaded rod is installed inside the transport shelf through a bearing, an outer side of the first threaded rod is fixedly sleeved with a second bevel gear, the second bevel gear is meshed with the first bevel gear, a second threaded rod is installed inside the transport shelf through the bearing, a thread direction of the second threaded rod is opposite to a thread direction of the first threaded rod, an outer side of the second threaded rod is fixedly sleeved with a third bevel gear, the third bevel gear is meshed with the first bevel gear, the outer side of the first threaded rod is connected to a first clamp plate by means of screw thread, the first clamp plate is slidably connected to the transport shelf, the first clamp plate comes into contact with a container body, and the outer side of the second threaded rod is connected to a second clamp plate by means of screw thread.

2. The hoisting protection device for container transportation according to claim 1, wherein a plurality of the clamp slots are provided, and the plurality of clamp slots are arranged in an annular array on the fastening bolt.

3. The hoisting protection device for container transportation according to claim 1, wherein one end of the second spring is welded to the guide ball, and other end of the second spring is welded to the fixed cylinder.

4. The hoisting protection device for container transportation according to claim 1, wherein an elastic disc is fixedly connected to the expansion rod, the elastic disc comes into contact with the friction sleeve, the elastic disc is fixedly connected to a friction block, and the friction block is slidably connected to the friction groove.

5. The hoisting protection device for container transportation according to claim 1, wherein a plurality of the friction grooves are provided, and the plurality of friction grooves are arranged in an annular array on the friction sleeve.

6. The hoisting protection device for container transportation according to claim 1, wherein the second clamp plate is slidably connected to the transport shelf, and the second clamp plate comes into contact with the container body.

7. The hoisting protection device for container transportation according to claim 1, wherein a clamp hole is provided in the output shaft, a clamp rod is slidably connected into the transport shelf, the clamp rod is slidably connected to the clamp hole, a third spring is welded onto the clamp rod, and other end of the third spring is welded to the transport shelf.

8. The hoisting protection device for container transportation according to claim 1, wherein a plurality of the clamp holes are provided, and the plurality of clamp holes are arranged in an annular array on the output shaft.
